(19) United States
(12) Patent Application Publication
(10) Pub. No.: US 2016/0309353 A1
(43) Pub. Date: Oct. 20, 2016

(54) PACKET DETECTION THRESHOLD CALIBRATION WITH ANTENNA CONNECTED

(71) Applicant: GainSpan Corporation, San Jose, CA (US)

(72) Inventor: Qiang Lin, San Jose, CA (US)

(21) Appl. No.: 14/686,710

(22) Filed: Apr. 14, 2015

(51) Int. Cl. H04W 24/08; H04B 17/345

(52) U.S. Cl. CPC H04W 24/08; H04B 17/345

(57) ABSTRACT

Systems and methods for determining a packet detection threshold for a wireless device with the antenna connected are disclosed. An energy detection algorithm, averaging algorithm and threshold computation algorithm may be performed to determine the packet detection threshold.

### BACKGROUND

1. Field

The present disclosure relates generally to wireless devices, and, more specifically, to systems and methods for performing packet detection threshold calibration in a wireless device with the antenna connected.

2. Related Art

A wireless network generally includes two or more wireless devices that communicate with each other over a wireless medium. One example of a wireless network is a wireless local area network (WLAN) designed to operate according to IEEE 802.11 standards.

All packet based communication systems, such as WLAN systems, need to be able to detect any incoming packets before receiving them. The performance is critical to the system performance —it has to be able to detect packets with very low power, which translates to good sensitivity, and it must not false detect too frequently. False detection causes the system to enter undesirable states, so the receiver will not be able to receive the packets coming in at the time.

In most systems, there is a block that monitors the incoming signal energy, and declares a packet when the energy is above a predefined threshold. When there is no packet, all it measures is noise power. Noise power in a system depends on its Noise Figure (NF) and gain. If the NF or gain changes, the noise power will also change. In the case of higher noise power, inevitably the system will false detect more frequently due to noise; in the case of lower noise power, the system becomes less sensitive as it requires more energy to cross the threshold.

A number of factors can affect noise measurements, including, for example, jammers at any power level and spurs. The noise floor (NF) of the low noise amplifier (LNA) also depends on its input impedance. Therefore, noise floor in the receive path varies across the designs as their antenna impedance change. It is impossible and impractical to predict the impedance in those final products; thus, it is impossible to predict the noise floor in final products. This uncertainty causes a problem in packet detection threshold setting, as knowledge of noise floor is required to set the threshold properly.

When a receiver is integrated in a final product and connected to an antenna, it is exposed to all kind of interferences from other transmitters, microwave ovens, other appliances. The noise measurement cannot be consistent if the total in-band power is measured as if it is still in a shield box.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Noise floor in a system depends on many factors, the source impedance to the input of the system (in a WLAN system, it is antenna to the input pin of the receiver IC). To capture the noise floor of the system in its operation mode, it is important to include the contribution of the antenna. Embodiments of this invention relate to systems and methods that measure the noise floor in the system with the antenna connected. Embodiments of the invention also related to systems and methods that adjust the packet detection threshold according to noise floor to achieve more reliable and uniform performance. In particular, calibration is performed with the antenna, after the wireless chipset is integrated into the final products.

In accordance with an aspect of the invention, a wireless device is disclosed that includes a receiver to receive a receive signal from one or more other wireless devices; an antenna coupled to the receiver; a processor configured to detect an energy level of signals received at the receiver, determine the average noise power of the signals received at the receiver and compute a packet detection threshold that exceeds the average noise floor of the wireless device; and memory to store the packet detection threshold.

The packet detection threshold may be variable. The threshold for packet detection may be variable over temperature.

The wireless device may be configured to detect packets when the energy level of the signal exceeds the packet detection threshold.

The packet detection threshold may be adjusted according to the noise floor.

In accordance with yet another aspect of the invention, a method is disclosed that includes performing an energy detection algorithm at a wireless device having an antenna connected thereto on a plurality of wireless signals received at the wireless device; and applying a noise power averaging algorithm to determine a noise floor measurement for the wireless device with the antenna connected.

The method may further include performing a threshold computation based on the average noise floor determined by the noise power averaging algorithm.

Performing the energy detection algorithm may include computing a total energy of a signal captured at the antenna of the wireless device. The method may further include comparing the total energy of the captured signal to a previously averaged value.

The computed energy value may be discarded if it is higher than the previously averaged value. The computed energy value may be used in the averaging algorithm if the energy is lower than the previously averaged value. The previously averaged value may be discarded if the computed energy value is significantly lower than previous value.

The average noise power level may be the true noise floor of the wireless device.

The threshold computation may determine a threshold for packet detection. The threshold may be variable. The threshold for packet detection may be variable over temperature.

The wireless device may detect packets when the signal energy exceeds the threshold.

The threshold for packet detection may be adjusted according to the noise floor.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a block diagram of an exemplary wireless communication system.

FIG. 2 is a graph showing different in-band noise floors for a device having the same antenna but different cable lengths.

FIGS. 3A and 3B are graphs showing the power and DAC values for a wireless device.

FIG. 4 is a graph showing the noise measurement for a wireless device with the antenna connected in accordance with one embodiment of the invention.

FIG. 5 is a schematic diagram illustrating calibration of the wireless device based on the noise floor in accordance with one embodiment of the invention.

FIG. 6 is a graph of a noise measurement in accordance with one embodiment of the invention.

FIG. 7 is a graph of a noise measurement in accordance with one embodiment of the invention.

FIG. 8 is a graph of a noise measurement in accordance with one embodiment of the invention.

FIG. 9 is a flow diagram illustrating a method for computing a packet threshold for a wireless device in accordance with one embodiment of the invention.

FIG. 10 is a detailed flow diagram illustrating a method for determining a packet detection threshold for a wireless device in accordance with one embodiment of the invention.

FIG. 11 is a block diagram of a wireless device in accordance with one embodiment of the invention.

### DETAILED DESCRIPTION

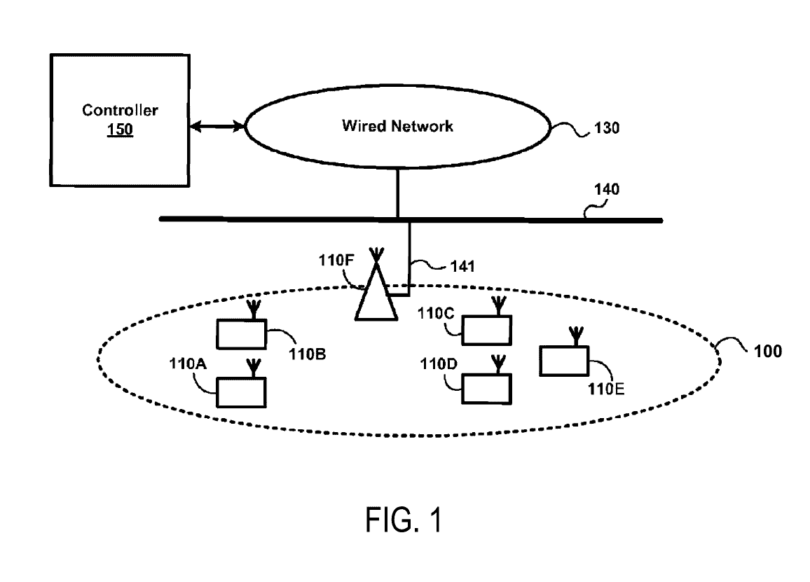

FIG. 1 illustrates an exemplary network including both wired and wireless components. It will be appreciated that the network shown in FIG. 1 and described herein is exemplary and fewer or additional components may be included in the network and other variations may be made to the exemplary network are contemplated. In addition, although certain features of the network are described with reference to a network consistent with the IEEE 802.11 standards; it will be appreciated that the invention may be implemented in networks operating with other wireless network standards, such as, for example, HIPERLAN, IEEE 802.16, Bluetooth, cellular technologies, such as CDMA, WCDMA, LTE, etc., and others, or other non-standards-based wireless networks.

The network 100 illustrated in FIG. 1A includes clients 110A-110E, access point (AP) 110F, wired network 130, wired network backbone 140 and wirelesss network manager 150. Client 110 represents a basic service set (BSS) consistent with the 802.11 standard; however, as explained above, other wireless implementations are contemplated. The term clients as used herein refers to both end devices (e.g., wireless stations) and an access point.

A wireless local area network (WLAN) generally refers to a wireless network, which facilitates multiple devices to communicate with each other over a wireless medium, and typically includes both wireless stations and an access point. Wireless stations refer to end devices, which transmit and receive packets for communication with other wireless stations and/or other devices within or external to the WLAN. Access points typically refer to devices that are typically intended for receiving and transmitting packets to and receiving packets from the wireless stations and devices external to the WLAN. Access points also manage access to the network, controlling which stations may join, authenticating stations and managing security mechanisms. Access points typically forward or switch packets, send periodic beacons and in general communicate using packet formats designed for operation as an access point.

Access point 110F is connected by a wired medium 141 to wired network backbone 140, which is connected to wired network 130. Each of the clients 110A-110E may communicate with access point 110F as well as with one another wirelessly. The client devices 110A-110E communicate with the wired network 130 through the access point 110F. The wired network 130 may represent the Internet or World Wide Web. The clients 110A-110E may be, for example, a laptop computer, smart phone, wireless sensor, or the like.

Wireless network manager 150 transmits configuration and control messages to the access point 110F. Configuration and control messages that are addressed to the clients 110A-110E are forwarded by the access point 110F to the intended client device recipient 110A-110E by sending either a unicast or a broadcast message. Although the wireless network manager 150 is shown as a separate component from the access point 110F in FIG. 1A, it will be appreciated that the functionality of the wireless network manager 150 may be integrated within the access point 110F.

Wireless network manager 150 may additionally be designed to operate as a controller of BSS 110 and issue network commands to and receive data from one or more of the client devices 110A-110E, and may thus operate to provide certain desired features, such as, for example, building or plant automation, monitoring medical patients, remotely controlling a content storage device, etc. depending on the environment in which the network is deployed. The data received from the client devices 110A-110E may represent measured values of desired parameters, such as, for example, temperature, pressure, humidity, etc. in the case of building automation, measured medical data (e.g., heartbeat, blood pressure, blood glucose, temperature, etc.) about the patient in the case of medical monitoring, video or other data type content in the case of remote control of a content storage device. For example, the access point 110F may be a remote control that controls a client device 110A, and the client device 110A may be a GoPro video recorder. In another example, the client device 110A may be a human wearable tag for collecting blood pressure and the access point 110F may be a mobile phone for communicating the collected blood pressure data to a remote server accessible by a health care professional. It will be appreciated that embodiments of the invention may be implemented in numerous other scenarios.

One or more of client devices 110A-110E may be designed to operate in a “power-save” mode. For example, in the context of IEEE 802.11 standards operation, a client device (e.g., client device 110A) may operate in the standard Power Save Poll Mode (PSPM, or power-save mode, in general). Upon joining BSS 110, the client device 110A periodically “wakes up”, i.e., powers-ON for full functionality from a low power state, to transmit data to or receive data from the access point 110F or other client devices 110B-110E.

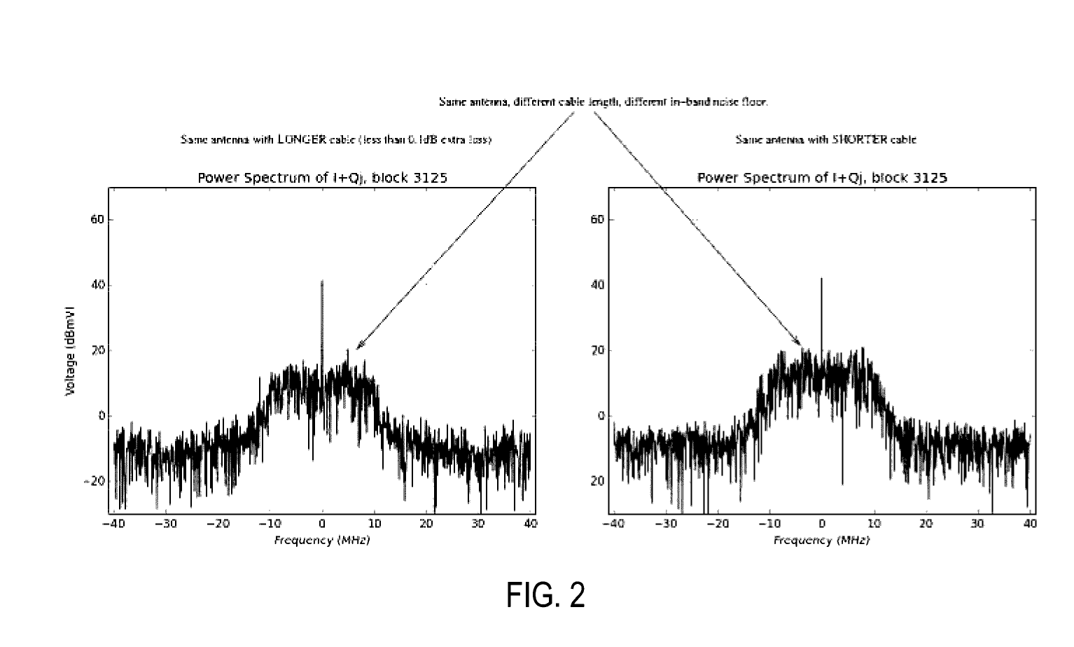

FIG. 2 illustrates that the noise floor for a wireless device is sensitive to the components of the wireless device. In particular, as shown in FIG. 2, the in-band noise floor for a wireless device having the same antenna but different length cables. Embodiments of the invention are able to measure this difference and update the packet detection threshold accordingly.

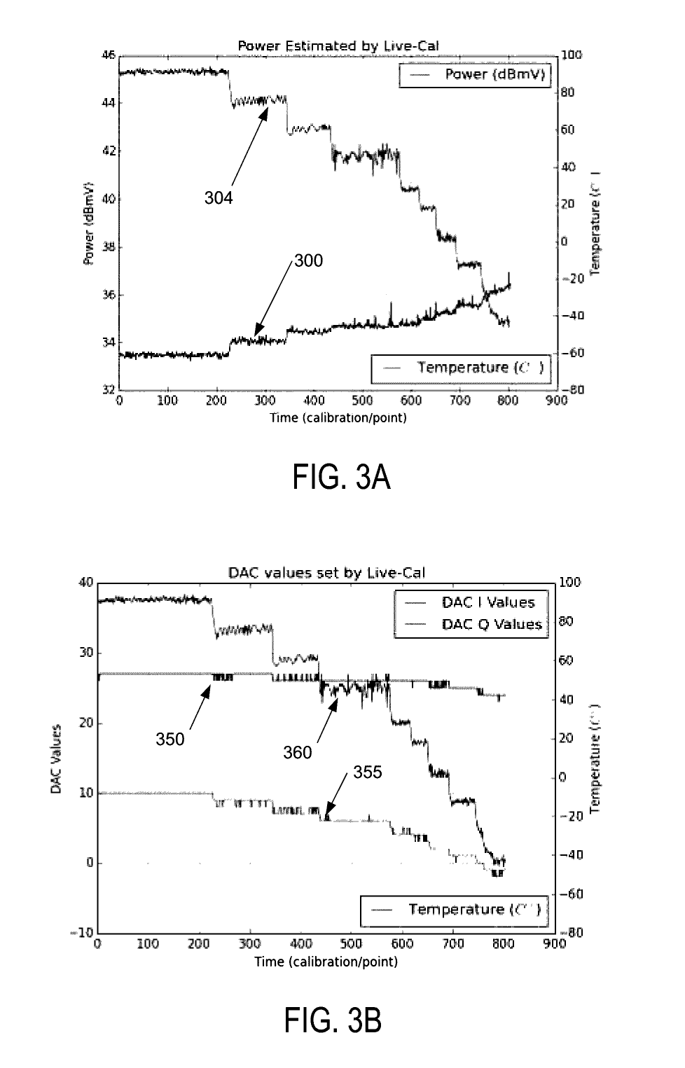

FIGS. 3A and 3B illustrate that the system power and noise floor are variable with temperature. FIG. 3A illustrates that the power (line 300) of the system increases as the temperature (line 305) decreases. Thus, the relationship is an inverse relationship. FIG. 3B illustrates that the DAC values (e.g., voltage) in the I and Q (lines 350 and 355, respectively) vary with temperature (block 360) in an incremental manner. The packet detection threshold can be set to vary with temperature. As demonstrated in FIGS. 3A and 3B, the noise to temperature relationship is an inverse relationship, and the threshold can be adjusted based on the noise. In one embodiment, the variable threshold values are stored in a look-up table in memory of the processor.

Embodiments of the invention use an energy detection algorithm to decide whether the signal is clean enough that it can be used for noise measurements and an averaging algorithm. The averaging algorithm averages the noise power to further eliminate the uncertainty in the measurements. Spurs are included in the measurements, as they are always in the system. In some embodiments, the algorithms use long observation time to find gaps between packets, monitor the total energy in the captures, accept measurements that are lower than previous value +0.5 dB (noise power does not increase), reject measurements that are more than 0.5 dB higher than previous value, and enforce long observation time (1000 captures) to ensure that some quiet periods have been captured.

Instead of trying to distinguish all kind of interferences, the algorithms disclosed herein measure the total power in-band. If the measured value showed an abrupt increase from the current value, it is considered as jammed and should be discarded. An abrupt decrease is acceptable because this can happen if the current value is of power measured with jammers. The thermal noise level does not change unless temperature changes, and is assumed that temperature does not change abruptly on the order of milliseconds. To further smooth out the randomness due to the nature of thermal noise (modeled as Gaussian), a moving average is applied to the noise power and DC offset measurements. Details of the exemplary energy detection and averaging algorithm for determining the DC offset of the wireless device will now be described. In one embodiment, the following procedure is performed each time when the receiver has filled the 1024-sample buffer from the ADC. First, the average of 1024 samples is determined to obtain the DC of the system. The total power of the 1024 samples is computed—this value includes the contribution of DC. The AC power is computed by subtracting DC power (voltage squared) from the total power. This AC power is compared with a predetermined threshold. In one embodiment, the predetermined threshold is 0.5 dB above current power value. It will be appreciated that the predetermined threshold may be any value or range of values less than 0.05 dB or any value or range of values greater than 0.05 dB. If the new AC power is higher than this threshold, the new measurement is ignored. If the new AC power is below this threshold, the moving average buffers are updated. The new averaged AC power and DC offsets are computed from the data in buffers.

In one embodiment, there is a counter to count the number of ignored measurements. This counter is reset to 0 each time an update occurs. In one embodiment, the buffers need to be re-initialized when this counter exceeds 3,000 (current setting that is more than 38 ms).

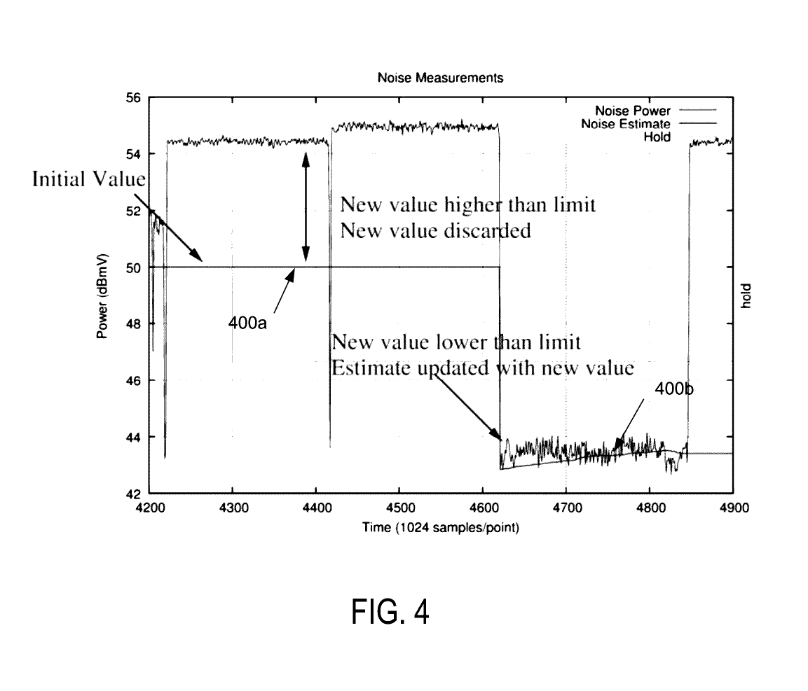

An example demonstrating the algorithm is shown in FIG. 4. As soon in FIG. 4, as the “hold” signal goes from high to low, the processing starts. At the beginning, the new measurement 400a is higher than the limit (0.5 dB above previous/initial value), so the algorithm ignores the new data. The moment that the interfering packet goes away, the new measurement 400b reflects the noise power and is lower than the limit, it is taken by the algorithm to update the averaged result.

Current IQ ADC outputs are 10-bit SIGNED integers and the processor supports 32-bit SIGNED integers natively. The process of computing the averaged power or DC will not cause any over flow for the given 1024-sample size. In the example, the current averaged power is Pc and the new measurement is Pn. Using the 0.5 dB criterion, Pc is compared with Pn×1122/1000. Once Pn has passed the test, the moving average buffer is updated with this new measurement (both power and DC in their respective buffers), and the averaging results. If the sum of the values in the buffer is Sn at time n, the averaged result is simply Sn/64.

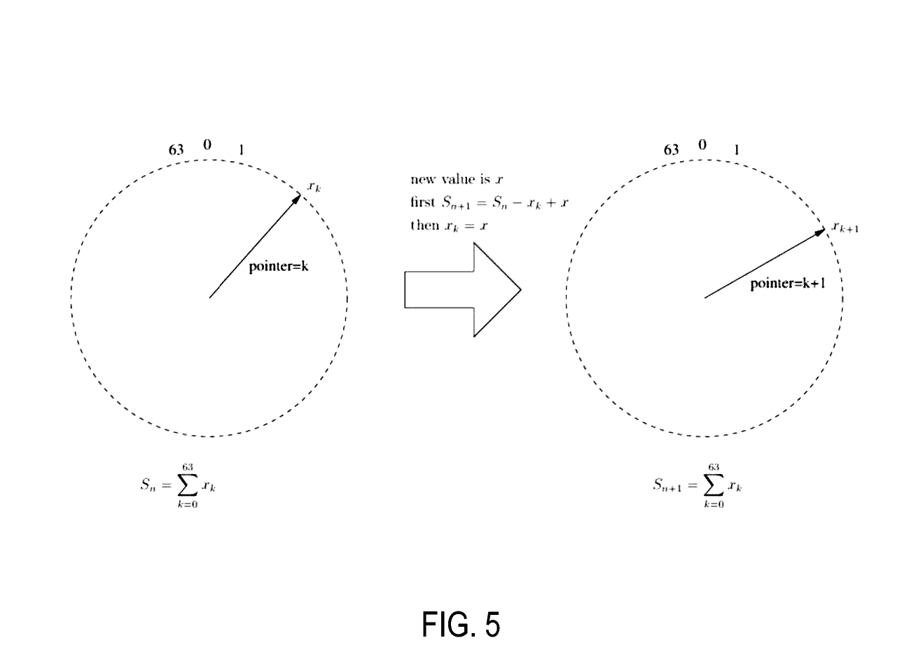

The new value is denoted as x in FIG. 5. At time n, the sum Sn is used to update the results and the buffer with the new value x, and Sn+1=Sn−xk+x is updated assuming the pointer was pointing to location k in the buffer. Then, the old value xk is replaced with x. After these operations, the pointer is increased to point to next position. The pointer shown in FIG. 5 can be implemented as an increasing integer p modulo 64, i.e., p is the remainder of p divided by 64. It can also be implemented as p bitwise and 63.

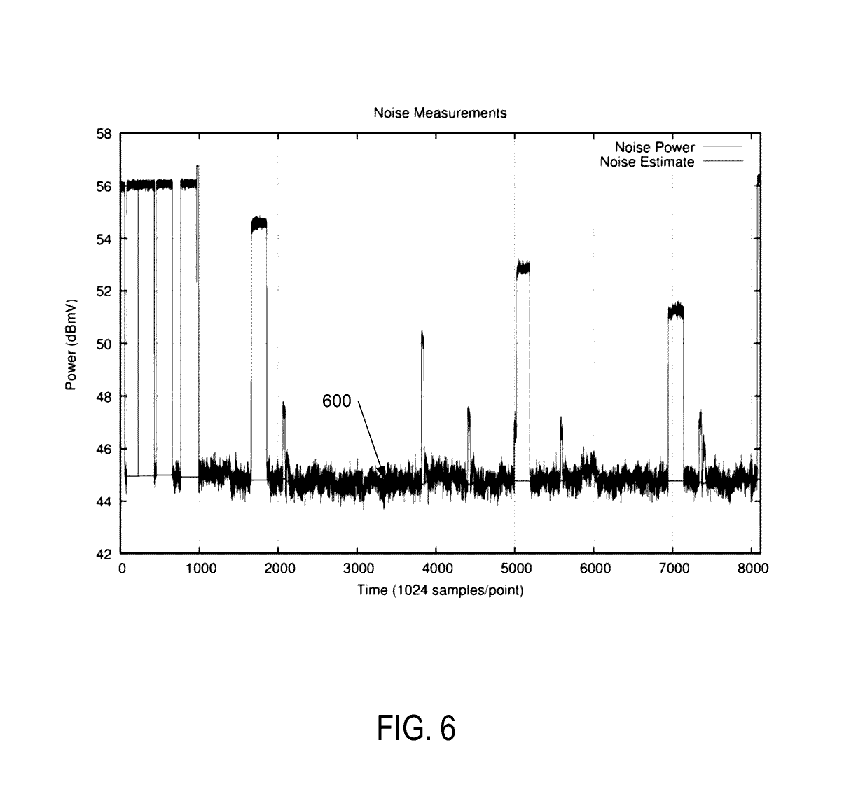

FIG. 6 illustrates the tracking capability of the algorithm. In particular, FIG. 6 illustrates measurement of the noise power of the signal over a period of time. The energy detection and averaging algorithms described herein are able to estimate the noise floor of the system, as reflected by line 600 in FIG. 6. Despite the strong interference at the beginning in FIG. 6, the algorithms converged to the target region quickly.

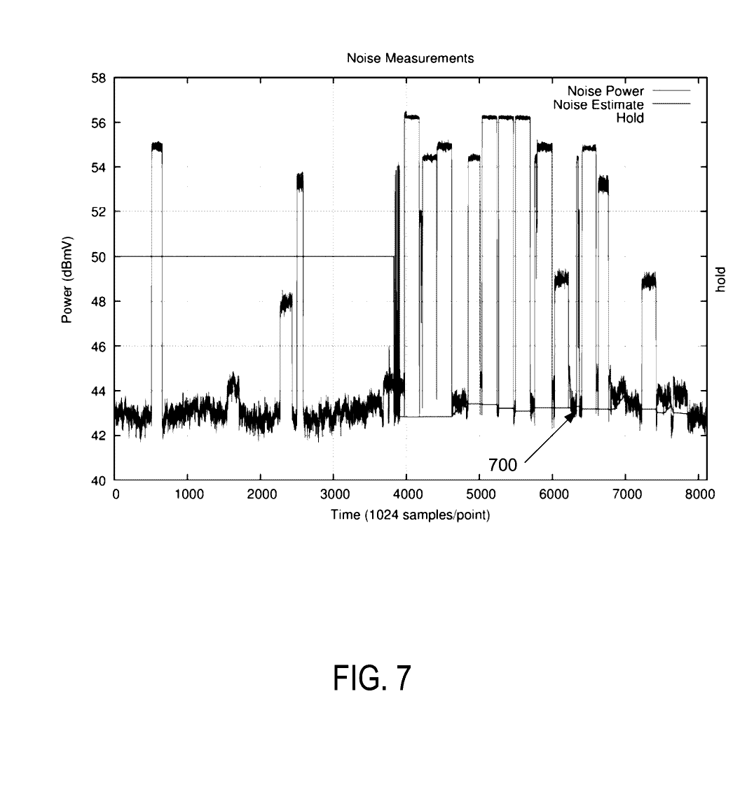

FIG. 7 further illustrate the robustness of the energy detection and averaging algorithm. In FIG. 7, the process was put on “hold” for a certain amount of time to start just before some high power packets came in. In FIG. 7, there is a “hold” signal that indicates the starting point of the process at its falling edge. In FIG. 7, the algorithms were able to determine the noise floor of the system as shown by line 700.

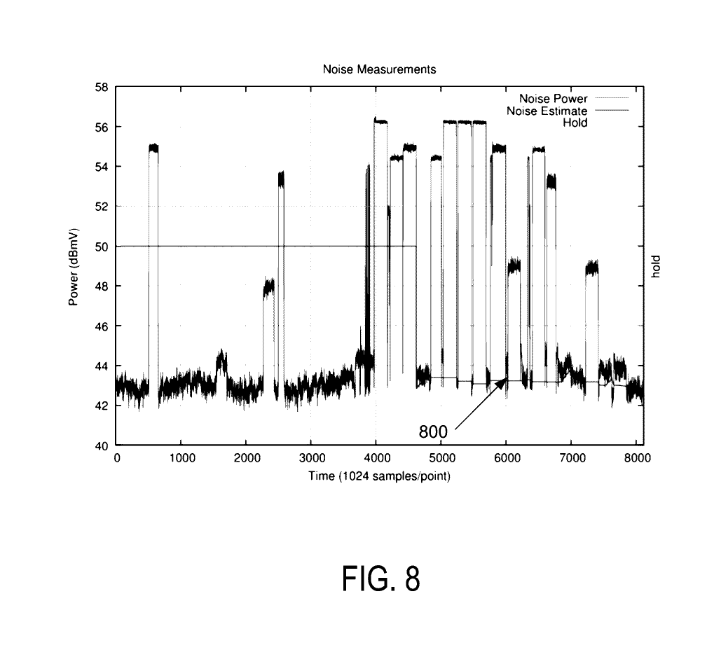

FIG. 8 illustrates that the algorithms work when they are started in the middle of receipt of packets. Again, the algorithm converged to the target region quickly as reflected by the noise estimate 800.

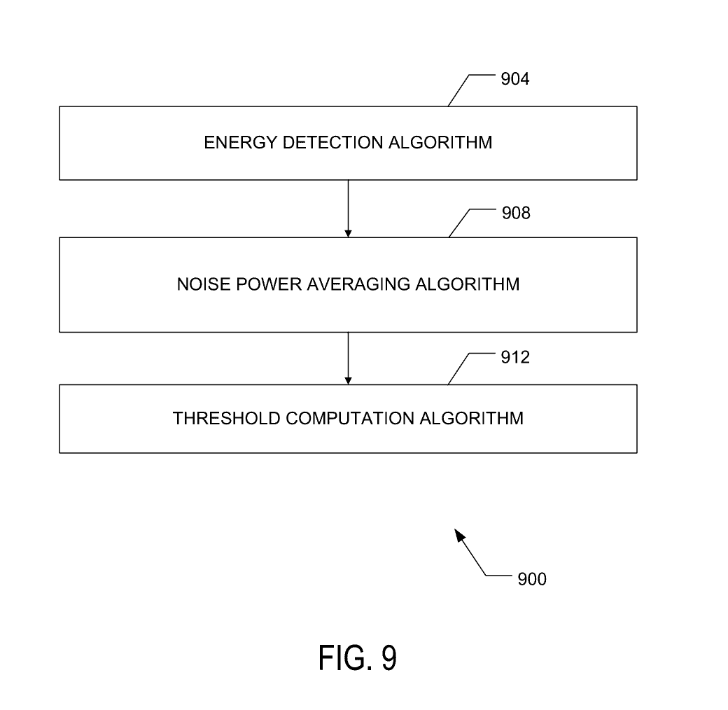

FIG. 9 illustrates a method for computing the packet detection threshold for a wireless device. The method 900 begins by performing an energy detection algorithm (block 904) and a noise power averaging algorithm (block 908). The method 900 continues by performing a threshold computation algorithm (block 912). The energy detection and noise power averaging algorithms ensure that the noise floor measurement is not affected by interference. The energy detection and noise power averaging algorithms are closely coupled to reject interference and provide reliable noise floor reading in spite the random nature of noise. The threshold computation algorithm adapts the system to the measured noise floor. The threshold computation based on the noise floor ensures that all products have a uniformed performance regardless of the noise floor variation from part to part. In one embodiment, the threshold is variable, reflecting temperature impacts on the noise floor.

It will be appreciated that the detection threshold computation is optional. For example, the energy detection and noise averaging algorithms may be used to determine the noise floor in the system for any reason. This determination can be used, for instance, to characterize the system's behavior and estimate the achievable performance or correlate the performance of the device with the measured noise floor.

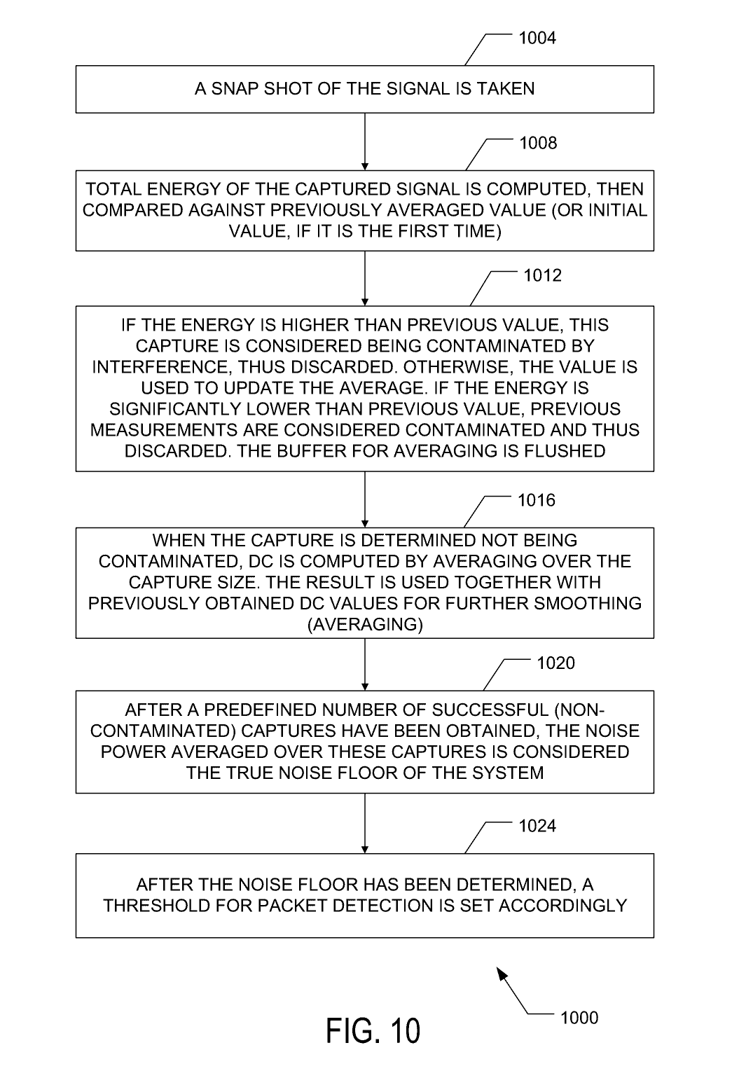

FIG. 10 illustrates a detailed method for determining the packet detection threshold for a wireless device. As shown in FIG. 10, the process 1000 begins by taking a snap shot of the signal (block 1004).

The process 1000 continues by computing the total energy of the captured signal (block 1008). The total energy is compared against the previously averaged value or is set as the initial value if it is the first time (block 1008).

The process 1000 continues by identifying whether the captured data is contaminated by interference (block 1012). If the energy is higher than previous value, the capture is considered to be contaminated by interference, and is thus discarded. Otherwise, the data is used to update the average. If the energy is significantly lower than previous value, the previous measurements are considered contaminated and are therefore discarded, and the buffer for averaging is flushed.

The process 1000 continues by computing the DC for the wireless device if the data is not contaminated by interference (block 1016). The DC is computed by averaging over the capture size. The result is used together with previously obtained DC values for further smoothing (averaging).

The process 1000 continues by averaging the noise power over the captured data to determine the noise floor of the system (block 1020). After a predefined number of successful (non-contaminated) captures have been obtained, the noise power averaged over these captures is considered the true noise floor of the system.

The process 1000 continues by setting a packet detection threshold for the wireless device based on the determined noise floor (block 1024). In some embodiments of the invention, the packet detection threshold is stored in the memory of the wireless device. In some embodiments, the packet detection threshold is set to be variable with temperature. For example, the packet detection threshold may vary incrementally and inversely with the temperature, reflecting the changes in noise floor based on temperature variations.

Advantages of the method disclosed herein include better and more consistent performance of the wireless device, more aggressive packet detection allowed without impact by sample variations, sensitivity only affected by NF over temperature (not by gain), internal spurs will only degrade sensitivity (not causing humps), and the like. It will be appreciated that it is possible to adapt to the DC and noise floor change due to environments when mounted on massive metal body, and when the antenna has been changed. Additional advantages include lower calibration cost, yield improvement, close to 100% calibration correctness unaffected by impedance, and similar sensitivity across all modules.

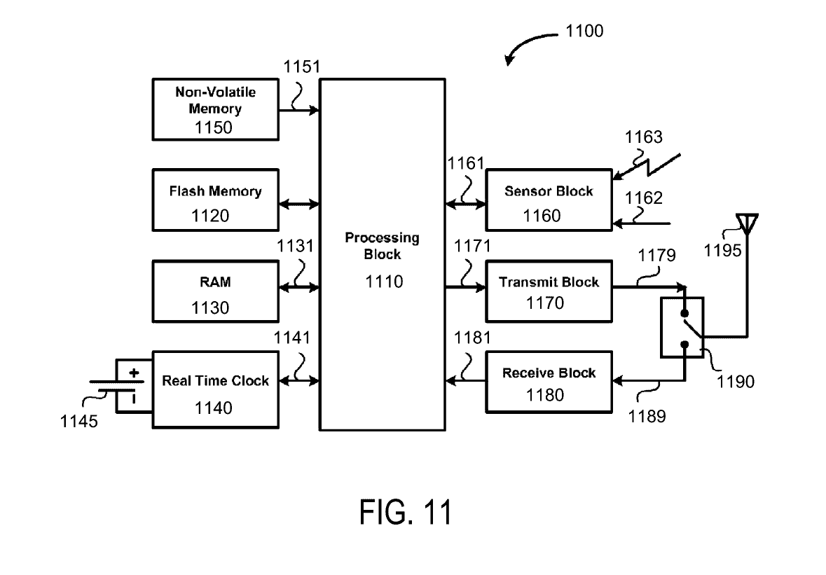

FIG. 11 illustrates exemplary components of a wireless device 1100. The wireless device 1100 corresponds to the wireless station or client device 110A-110E shown in FIG. 1 and described herein. It will be appreciated that the access point 110F typically includes the similar components to those shown in FIG. 11; however, the access point 110F may include fewer components than shown in the wireless device of FIG. 11 and may also include additional components than those shown in FIG. 11, and that the arrangement of the components may differ.

Exemplary implementations of wireless device 1100 are disclosed in U.S. Pat. No. 7,941,682, entitled “Optimum Power Management of System on Chip Based on Tiered States of Operation”, issued May 10, 2011, and U.S. Patent Publication Nos. 2009/0016251, entitled “Management System and Method of Low Power Consuming Devices, filed Jul. 13, 2007, 2009/0077404, entitled “Method and System for Reducing Power Consumption of System on Chip Based Analog-to-Digital Control Circuitry,” filed Sep. 14, 2007, each of which is assigned to Gainspan, Inc., the entireties of each of which are hereby incorporated by reference. It will be appreciated that other implementations of the wireless device 1100 are contemplated and such wireless device 1100 should not be limited to the disclosures incorporated by reference or the exemplary wireless device illustrated in FIG. 11.

Wireless device 1100 includes a data processing system 1110, flash memory 1120, random access (RAM) memory 1130 a real-time clock (RTC) 1140, power supply 1145, non-volatile memory 1150, sensor(s) 1160, a transmitter 1170, a receiver 1180, switch 1190 and antenna 1195. It will be appreciated that the wireless device 1100 may be implemented as a system-on-chip (SoC) or as separate integrated circuits (IC) or combinations thereof. Additionally, it will be appreciated that the wireless device 1100 may have fewer or greater components than those shown in FIG. 11 and that the arrangement of the components shown in FIG. 11 may differ.

Data processing system 1110 is a processor that may contain one or more processing units. In embodiments in which the data processing system 1100 includes multiple processing units, each processing unit may be designed for a specific task. Alternatively, the data processing system 1110 may contain a general purpose processing unit. In yet another embodiment, the data process system 1110 may contain multiple general purpose processing units that share processing for all tasks in a mutual way.

Flash memory 1120 contains memory locations organized as blocks. A block represents a set of memory locations (typically continuous in terms of memory address) which are to be all erased before data can be rewritten into any location. Flash memory 1120 may be used to store data from sensor(s) 1160 via data processing system 1110 and/or store program code.

RAM 1130 and non-volatile memory 1150 (which may be implemented in the form of read-only memory (ROM)) constitute computer program products or machine readable medium which provide instructions to data processing system 1110. RAM 1130 communicates with data processing system via path 1131. The non-volatile memory 1150 may include sub-components (not shown), such as OTP and EEPROM.

RTC 1140 operates as a clock and provides the current time to data processing system 1110 on path 1141. RTC 1140 may be backed-up by power supply 1145. RTC 1140 may also contain memory to store critical information received from the data processing system 1110.

Non-volatile memory 1150 is a non-transitory computer readable medium that stores instructions, which when executed by the data processing system 1110, cause the wireless device 1100 to process the data and messages received from the receiver and generate the data and messages for transmission by the transmitter. The non-volatile memory communicates with data process system 1110 via path 1151.

Sensor(s) 1160 may include one or more sensors as well as corresponding signal conditioning circuitry. As an alternative, sensor(s) may instead be any data capture device, such as a video recording device or other data collection or capture devices. Sensed parameters or data are transmitted on path 1161 via a wired path 1162 or wireless path 1163.

Transmitter 1170 receives data to be transmitted from data processing system 1110 on path 1171. Further, the transmitter 1170 generates a modulated radio frequency (RF) signal according to IEEE 802.11 standards and transmits the RF signal via switch 1190 and antenna 1195.

Receiver 1180 receives an RF signal bearing data via switch 1190 and antenna 1195. The receiver 1180 further demodulates the RF signal and provides extracted data to the data processing system 1110 on path 1181.

Antenna 1195 operates to receive from and transmit to a wireless medium wireless signals containing data and messages. Switch 1190 may be controlled by the data processing system 1110 to connect antenna 1195 to the receiver 1180 via path 1189 or transmitter via path 1179 depending on whether the wireless station is receiving or transmitting.

One or more of the methodologies or functions described herein may be embodied in a computer-readable medium on which is stored one or more sets of instructions (e.g., software). The software may reside, completely or at least partially, within memory, as described above, and/or within the data processing system during execution thereof. The software may further be transmitted or received over a network.

The term “computer-readable medium” should be taken to include a single medium or multiple media that store the one or more sets of instructions. The term “computer-readable medium” shall also be taken to include any medium that is capable of storing, encoding or carrying a set of instructions for execution by a machine and that cause a machine to perform any one or more of the methodologies of the invention. The term “computer-readable medium” shall accordingly be taken to include, but not be limited to, solid-state memories, and optical and magnetic media.

Embodiments of the invention have been described through processes or flow diagrams at times, which are defined by executable instructions recorded on computer readable media which cause a computer, microprocessors or chipsets to perform method steps when executed. The process steps have been segregated for the sake of clarity. However, it should be understood that the steps need not correspond to discreet blocks of code and the described steps can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The invention has been described in relation to particular examples, which are intended in all respects to be illustrative rather than restrictive. Those skilled in the art will appreciate that many different combinations of hardware, software, and firmware will be suitable for practicing the present invention.

The present invention has been described in relation to particular examples, which are intended in all respects to be illustrative rather than restrictive. Those skilled in the art will appreciate that many different combinations will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A wireless device comprising:
a receiver to receive a receive signal from one or more other wireless devices;
an antenna coupled to the receiver;
a processor configured to detect an energy level of signals received at the receiver, determine the average noise power of the signals received at the receiver and compute a packet detection threshold that exceeds the average noise floor of the wireless device; and
memory to store the packet detection threshold.

2. The wireless device of claim 1, wherein the packet detection threshold is variable.

3. The wireless device of claim 2, wherein the threshold for packet detection is variable over temperature.

4. The wireless device of claim 2, wherein the wireless device is configured to detect packets when the energy level of the signal exceeds the packet detection threshold.

5. The wireless device of claim 2, wherein the packet detection threshold is adjusted according to the noise floor.

6. A method comprising:
performing an energy detection algorithm at a wireless device having an antenna connected thereto on a plurality of wireless signals received at the wireless device; and
applying a noise power averaging algorithm to determine a noise floor measurement for the wireless device with the antenna connected.

7. The method of claim 6, further comprising performing a threshold computation based on the average noise floor determined by the noise power averaging algorithm.

8. The method of claim 6, wherein performing the energy detection algorithm comprises computing a total energy of a signal captured at the antenna of the wireless device.

9. The method of claim 8, further comprising comparing the total energy of the captured signal to a previously averaged value.

10. The method of claim 5, wherein the computed energy value is discarded if it is higher than the previously averaged value.

11. The method of claim 9, wherein the computed energy value is used in the averaging algorithm if the energy is lower than the previously averaged value.

12. The method of claim 9, wherein the previously averaged value is discarded if the computed energy value is significantly lower than previous value.

13. The method of claim 6, wherein the average noise power level is the true noise floor of the wireless device.

14. The method of claim 7, wherein the threshold computation determines a threshold for packet detection.

15. The method of claim 14, wherein the threshold is variable.

16. The method of claim 14, wherein the threshold for packet detection is variable over temperature.

17. The method of claim 14, wherein the wireless device detects packets when the signal energy exceeds the threshold.

18. The method of claim 14, wherein the threshold for packet detection is adjusted according to the noise floor.
